(19) United States
(12) Patent Application Publication
(10) Pub. No.: US 2025/0230178 A1
(43) Pub. Date: Jul. 17, 2025

(54) DEVICE FOR FULLY-CONTINUOUS SYNTHESIS OF GLYPHOSATE

(71) Applicants: HUBEI XINGFA CHEMICALS GROUP CO.,LTD., Yichang (CN); HUBEI TRISUN CHEMICALS CO.,LTD., Yichang (CN)

(72) Inventors: Fener CHEN, Yichang (CN); Xianjing ZHENG, Yichang (CN); Chang LIU, Yichang (CN); Yiqun TIAN, Yichang (CN); Yajiao ZHANG, Yichang (CN); Li WAN, Yichang (CN); Chunxue PENG, Yichang (CN); Songlin ZHENG, Yichang (CN); Liangchuan LAI, Yichang (CN)

(21) Appl. No.: 19/097,441

(22) Filed: Apr. 1, 2025

(30) Foreign Application Priority Data
Apr. 24, 2024 (CN) 202410496609.6

(51) Int. Cl. C07F 9/38

(52) U.S. Cl. CPC C07F 9/3813; C07B 2200/13

(57) ABSTRACT

A device for fully-continuous synthesis of glyphosate is provided. The device includes a first feed pump, a second feed pump, a third feed pump, a fourth feed pump, a fifth feed pump, a six feed pump, a seventh feed pump, a first micromixer, a second micromixer, a third micromixer, a fourth micromixer, a first microchannel reactor, a second microchannel reactor, a third microchannel reactor, a fourth microchannel reactor, a fifth microchannel reactor, a sixth microchannel reactor, a first stirring vessel, a second stirring vessel, a third stirring vessel, a buffer tank, a first back pressure valve, a second back pressure valve and a continuous crystallizer that are connected according to a glyphosate synthesis route. The device can realize continuous production of glyphosate.

### CROSS-REFERENCE TO RELATED APPLICATIONS

This application claims the benefit of priority from Chinese Patent Application No. 202410496609.6, filed on Apr. 24, 2024. The content of the aforementioned application, including any intervening amendments made thereto, is incorporated herein by reference in its entirety.

### TECHNICAL FIELD

This application relates to fine chemical industry, and more particularly to a device for fully-continuous synthesis of glyphosate.

### BACKGROUND

Glyphosate is a potent, low-toxic, broad-spectrum, lethal, non-selective herbicide with excellent biological properties, which is a pesticide variety with the largest production in the world. In China, 70% of glyphosate is produced by the alkyl ester method with glycine and dimethyl phosphite as the main raw materials. This method uses methanol as the reaction solvent. In the presence of triethylamine catalyst, glycine, polyformaldehyde and dimethyl phosphite are reacted to obtain glyphosate. The glycine method of glyphosate production has a history of more than 30 years. The processes of solvent recovery, triethylamine recovery, and methyl chloride recovery have been realized in industry. However, the reaction process and crystallization process still adopt batch or continuous reactors, which results in low production efficiency, low degree of continuity, unstable product quality batches and large discharge of three wastes.

Chinese patent publications No. 111205319A and No. 110862413A, and Chinese patents No. 216630779U and No. 104163832B disclosed continuous tank-type synthesis devices and corresponding processes, which still require a large number of reaction vessels to meet the requirements of industrial production, resulting in a large production footprint, a large amount of online reaction materials and solvents, and a high process safety risk. In addition, the crystallization and purification of the final glyphosate product is still carried out in the reaction vessel, resulting in low production efficiency and unstable glyphosate quality in individual batches.

### SUMMARY

In view of the problems in the prior art, an object of the disclosure is to provide a device for fully-continuous synthesis of glyphosate with high production efficiency, desirable product quality and low emission of three wastes.

The device provided in this application adopts microchannel reactors, a rotary dynamic reactor, a vessel-type continuous hydrolysis dealcoholization reactor and a continuous crystallizer for coupling according to the reaction process characteristics, fully-continuous manufacturing from raw material feeding to glyphosate finished product. This not only facilitates the expansion of production capacity and avoids the problem of uneven product quality in individual batches, but also improves the automated control, reduces the consumption of reagents and the discharge of three wastes. Compared with the existing production technologies, the device in this application significantly enhances the yield and quality stability with reduced production costs.

In order to achieve the above object, the following technical solutions are adopted.

This application provides a device for fully-continuous synthesis of glyphosate, comprising:
a first feed pump;
a second feed pump;
a third feed pump;
a fourth feed pump;
a fifth feed pump;
a sixth feed pump;
a seventh feed pump;
a first micromixer;
a second micromixer;
a third micromixer;
a fourth micromixer;
a first microchannel reactor;
a second microchannel reactor;
a third microchannel reactor;
a fourth microchannel reactor;
a fifth microchannel reactor;
a sixth microchannel reactor;
a first stirring vessel;
a second stirring vessel;
a third stirring vessel;
a buffer tank;
a first back pressure valve;
a second back pressure valve; and
a continuous crystallizer;
wherein the first feed pump is configured to transport a first material to the first micromixer, and the second feed pump is configured to transport a second material to the first micromixer, wherein the first material is a paraformaldehyde solution, and the second material is a solvent-free alkali or an alkali solution;
the first micromixer is configured to mix the first material with the second material to obtain a first mixture, and transport the first mixture to the first microchannel reactor through a first pipeline;
the first microchannel reactor is configured for depolymerization of paraformaldehyde to obtain a first reaction liquid, and transport the first reaction liquid to the second micromixer;
the third feed pump is configured to transport a third material to the second micromixer, wherein the third material is a glycine solution or dispersion;
the second micromixer is configured to mix the first reaction liquid with the third material to obtain a second mixture, and transport the second mixture to the second microchannel reactor;
the second microchannel reactor is configured for addition reaction of the second mixture to obtain a second reaction liquid;
the buffer tank is configured to receive the second reaction liquid from the second microchannel reactor through a second pipeline;
the fourth feed pump is configured to transport the second reaction liquid from the buffer tank to the third micromixer, and the fifth feed pump is configured to transport a fourth material to the third micromixer, wherein the fourth material is a solvent-free dimethyl phosphite or a dimethyl phosphite solution;
the third micromixer is configured to mix the second reaction liquid with the fourth material to obtain a third mixture, and transport the third mixture to the third microchannel reactor through a third pipeline;
the third microchannel reactor is connected to the fourth microchannel reactor, and the third microchannel reactor and the fourth microchannel reactor are configured for esterification of the third mixture to obtain a third reaction liquid; wherein a temperature of the fourth microchannel reactor is higher than that of the third microchannel reactor;
the first back pressure valve is configured to adjust a reaction pressure in the third microchannel reactor and a reaction pressure in the fourth microchannel reactor, and transport the third reaction liquid from the fourth microchannel reactor to the fourth micromixer;
the sixth feed pump is configured to transport a fifth material to the fourth micromixer, wherein the fifth material is a solvent-free acid or an acid solution;
the fourth micromixer is configured to mix the third reaction liquid with the fifth material to obtain a fourth mixture, and transport the fourth mixture to the fifth microchannel reactor;
the fifth microchannel reactor is configured for neutralization of the fourth mixture to obtain a fourth reaction liquid, and transport the fourth reaction liquid to the sixth microchannel reactor through a fourth pipeline;
the sixth microchannel reactor is configured for hydrolyzing and heating the fourth reaction liquid to obtain a first hydrolysis product;
the second back pressure valve is configured to adjust a reaction pressure in the fifth microchannel reactor and a reaction pressure in the sixth microchannel reactor, and transport the first hydrolysis product from the sixth microchannel reactor to a lower inlet of the first stirring vessel;
the first stirring vessel is configured such that the first hydrolysis product undergoes desolventization at a lower portion of the first stirring vessel to obtain a first desolvated product and a vaporized gas; the vaporized gas enters a condensation collector through a fifth pipeline; the first desolvated product is allowed to flow upward from the lower portion of the first stirring vessel, leave the first stirring vessel from an upper outlet, and enter a lower portion of the second stirring vessel through a sixth pipeline;
the second stirring vessel is configured for desolventization of the first desolvated product to obtain a second desolvated product; the second product is allowed to flow upward from the lower portion of the second stirring vessel to an upper outlet of the second stirring vessel, and enter a lower portion of the third stirring vessel through a seventh pipeline for hydrolysis and dealcoholization to obtain a second hydrolysis product; and
the continuous crystallizer is configured to perform cooling crystallization on the second hydrolysis product discharged from the third stirring vessel to obtain a glyphosate product.

In some embodiments, the first feed pump and the third feed pump are each independently a peristaltic pump for slurry feeding, and the second feed pump, the fourth feed pump, the fifth feed pump, the sixth feed pump and the seventh feed pump are each independently a plunger pump for liquid feeding.

In some embodiments, the first micromixer, the second micromixer, the third micromixer and the fourth micromixer are each independently a micromixer composed of four rhombus tubular mixing components connected in series; and each of the four rhombus tubular mixing components has a circular cross-section or a square cross-section, a fluid channel size of 100 μm-20 mm, a length of 1-100 cm and an applicable flux of 1-3000 mL/min. The micromixers having such structure can ensure that the materials are mixed evenly.

In some embodiments, the second microchannel reactor is a rotary dynamic reactor having a cylindrical cavity; a wall of the cylindrical cavity is a heat-exchange fluid interlayer for a heat exchange fluid to pass through; a central shaft is provided in the cylindrical cavity; a plurality of stirring paddles are connected to the central shaft to enhance mass transfer and heat transfer; the central shaft is configured to be driven by a motor to rotate at 50-500 rpm; and the cylindrical cavity has a diameter of 3-60 cm, a length of 20-500 cm and an applicable flux of 10-50,000 mL/min. The microchannel reactor having such structure is suitable for continuous and stable operation of liquid-solid systems, and has a heat exchange area that is 8-10 times that of a traditional kettle reactor.

In some embodiments, the first microchannel reactor, the third microchannel reactor, the fourth microchannel reactor, the fifth microchannel reactor and the sixth microchannel reactor are each independently a tubular microreactor with a plurality of square mixing components axially provided therein; and the tubular microreactor has a fluid channel size of 2-500 mm, a length of 1-10000 m and an applicable flux of 10-50,000 mL/min. The microchannel reactor having such structure is used to separate and then converge the fluid, resulting in excellent uniformity of material mixing, and especially avoiding the problem of reduced mass transfer efficiency due to size expansion when enlarging.

In some embodiments, a pipeline connecting the fourth microchannel reactor and the first back pressure valve, a pipeline connecting the first back pressure valve and the fourth micromixer, a pipeline connecting the six microchannel reactor and the second back pressure valve, and a pipeline connecting the second back pressure valve and the lower inlet of the first stirring vessel each have an inner diameter of 1.6-20 mm and a pressure adjustment range of 0.1-2.0 MPa.

In some embodiments, the first stirring vessel, the second stirring vessel and the third stirring vessel are each independently a stirring vessel having a stirring paddle, a distillate outlet, a heat exchange jacket, a heat exchange fluid inlet, a heat exchange fluid outlet, a material inlet and a material outlet; and the first stirring vessel, the second stirring vessel and the third stirring vessel are connected in series through the sixth pipeline and the seventh pipeline; and the first stirring vessel, the second stirring vessel and the third stirring vessel each have an inner diameter of 5-1000 cm and a height of 5-1000 cm. The first stirring vessel, the second stirring vessel and the third stirring vessel are each made of glass, polytetrafluoroethylene, stainless steel, Hastelloy® alloy, tantalum, zirconium or a combination thereof.

In some embodiments, the continuous crystallizer is a tubular reactor having a mixing structure and a heat exchange jacket; the tubular reactor has an S-shaped inner tube and an S-shaped outer tube; a heat exchange interlayer is provided between the S-shaped inner tube and the S-shaped outer tube for a heat exchange fluid to pass through; a plurality of spherical baffles are arranged evenly spaced apart in the S-shaped tube; and the tubular reactor has an inner diameter of 2-20 cm, a length of 1-1000 m and an applicable flux of 10-5,000 mL/min. The tubular reactor is made of glass, polytetrafluoroethylene, stainless steel, Hastelloy® alloy, tantalum, zirconium or a combination thereof.

In some embodiments, the first microchannel reactor is configured to operate at 30-60° C. for 1-9 min; the second microchannel reactor is configured to operate at 45-80° C. for 6-12 min; the third microchannel reactor is configured to operate at 50-80° C. for 1-8 min; the fourth microchannel reactor is configured to operate at 60-90° C. for 5-15 min; the fifth microchannel reactor is configured to operate at 0-30° C. for 0.5-3 min; the sixth microchannel reactor is configured to operate at 90-190° C. for 0.5-3 min; the first stirring vessel is configured to hold the first hydrolysis product at 80-150° C. for 5-40 min; the second stirring vessel is configured to hold the first desolvated product at 80-150° C. for 5-40 min; the third stirring vessel is configured to hold the second desolvated product at 90-160° C. for 5-60 min; and the continuous crystallizer is configured to operate at 0-80° C. for 1-30 min.

Compared to the prior art, the present disclosure has the following beneficial effects.

In the device of the present disclosure, the rotary dynamic reactor is developed for the continuous and stable operation of a liquid-solid system, which has excellent plug flow effect. This not only solves the problems of poor reaction uniformity and unexpected by-products caused by back-mixing in traditional vessel-type reactors, but also has a heat exchange area that is 8-10 times that of the traditional vessel-type reactors, ensuring the consistency of product yield and quality during scale-up production. The tubular microreactor with the plurality of square mixing components arranged axially in sequence is developed for a liquid-liquid system. The microchannel reactor having such structure performs separation and reconvergence on the fluid, with a mixing frequency that is the n-th power of 2 times the number of components, which is the exponential mixing number. This allows the uniformity of material mixing to remain consistent when enlarging, avoiding the problem of reduced mass transfer efficiency and reduced yield caused by the enlargement of the device size. Finally, the high-efficiency continuous crystallizer realizes end-to-end continuous production from raw materials to qualified products, completes the integrated production of glyphosate, and avoids the problems large distribution range of devices, high energy consumption, long time consumption, and high difficulty in process safety control existing in traditional kettle production.

### BRIEF DESCRIPTION OF THE DRAWINGS

FIG. 1 is a flow chart of a method for fully-continuous synthesis of glyphosate using a device in accordance with an embodiment of the present disclosure; and

FIG. 2 is a structural diagram of a micromixer composed of four rhombus pipeline-type mixing components connected in series in accordance with an embodiment of the present disclosure.

### DETAILED DESCRIPTION OF EMBODIMENTS

The present disclosure will be further described with reference to the accompanying drawings and embodiments. The embodiments disclosed herein are merely illustrative of the disclosure, and are not intended to limit the present disclosure.

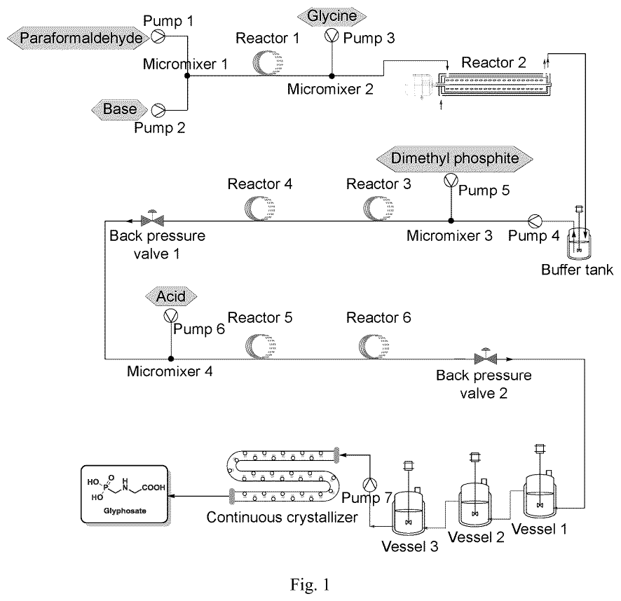

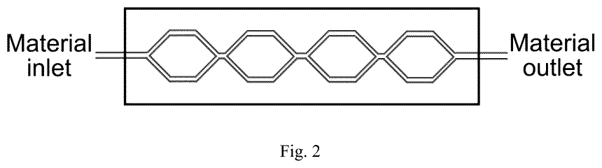

As shown in FIGS. 1-2, a device for fully-continuous synthesis of glyphosate is provided.

### Embodiment 1

A first material (0.64 kg/L of polyformaldehyde) was transported to a first micromixer by a first pump, and a second material (triethylamine) was transported to the first micromixer by a second pump. A volume flow ratio of the first material to the second material was 1:2. The first material and the second material were fully mixed in the first micromixer to obtain a first reactant liquid. The first reactant liquid was directly transported to a first reactor through a first connecting pipeline for depolymerization reaction of paraformaldehyde at 55° C. for 9 min to obtain a second reactant liquid. The second reactant liquid flowing out of the first reactor and a third material (0.41 kg/L of glycine) delivered by a third pump were fully mixed in a second micromixer, and then transported to a second reactor for addition reaction at 60° C. for 12 min to obtain a third reactant liquid. A volume flow ratio of the second reactant liquid to the third material was 1.1:1. The third reactant liquid was transported to a buffer tank through a second connecting pipeline, and then transported to a third micromixer by a fourth pump. A fifth material (dimethyl phosphite) was transported to the third micromixer by a fifth pump, such that the fifth material was fully mixed with the third reactant liquid, and then transported to a third reactor through a third connecting pipeline for esterification reaction at 60° C. for 8 min to obtain a fourth reactant liquid. A volume flow ratio of the third reactant liquid to the fifth material was 4:1. The fourth reactant liquid was outputted from the third reactor to enter a fourth reactor to continue the esterification reaction at 75° C., so that the reaction raw materials are completely converted, so as to obtain an esterification product. The esterification product was transported to a fourth micromixer through a first back pressure valve. Reaction pressures in the third and fourth reactors were adjusted by the first back pressure valve. A sixth material (35 wt. % aqueous hydrogen chloride solution) was transported to a fifth micromixer by a sixth pump. The esterification product was fully mixed with the sixth material in the fifth micromixer, and then subjected to neutralization reaction in a fifth reactor for 2.5 min to obtain a fifth reactant liquid. A volume flow ratio of the sixth material to the esterification product was 1:2. The fifth reactant liquid was directly transported to a sixth reactor through a fourth connecting pipeline for hydrolysis reaction at 150° C. for 2 min to obtain a hydrolysis product. At the same time, the hydrolysis product was heated, and then transported to a bottom portion of a first reaction vessel through a second back pressure valve. Reaction pressures in the fifth and sixth reactors were adjusted by the second back pressure valve to improve the removal efficiency of low-boiling point solvent and compound in the first reaction vessel. The hydrolysis product was retained in the first reaction vessel at 110° C. for 35 min to allow the low-boiling point solvent and compound to evaporate quickly. The vaporized gas was transported to a condensation collector through a fifth connecting pipeline. The remaining reaction mixture flowed upward from the bottom portion of the first reaction vessel to enter an upper outlet of the first reaction vessel, and then transported to a bottom portion of a second reaction vessel (130° C., 40 min) through a sixth connecting pipeline to remove the generated methyl chloride and part of water. The remaining reaction mixture flowed upward from the bottom portion of the second reaction vessel to enter an upper outlet of the second reaction vessel, and then transported to a lower portion of a third reaction vessel (140° C., 50 min) to allow complete hydrolysis and dealcoholization reaction. The obtained reaction product was transported to a continuous crystallizer for cooling crystallization at 65° C. for 15 min, so as to obtain a glyphosate finished product with a purity greater than 96% and a yield of 83% based on glycine.

### Embodiment 2

A first material (0.32 kg/L of polyformaldehyde) was transported to a first micromixer by a first pump, and a second material (triethylamine) was transported to the first micromixer by a second pump. A volume flow ratio of the first material to the second material was 2.5:1. The first material and the second material were fully mixed in the first micromixer to obtain a first reactant liquid. The first reactant liquid was directly transported to a first reactor through a first connecting pipeline for depolymerization reaction of paraformaldehyde at 50° C. for 6 min to obtain a second reactant liquid. The second reactant liquid flowing out of the first reactor and a third material (0.21 kg/L of glycine) delivered by a third pump were fully mixed in a second micromixer, and then transported to a second reactor for addition reaction at 65° C. for 10 min to obtain a third reactant liquid. A volume flow ratio of the second reactant liquid to the third material was 1:1. The third reactant liquid was transported to a buffer tank through a second connecting pipeline, and then transported to a third micromixer by a fourth pump. A fifth material (dimethyl phosphite) was transported to the third micromixer by a fifth pump, such that the fifth material was fully mixed with the third reactant liquid, and then transported to a third reactor through a third connecting pipeline for esterification reaction at 70° C. for 4 min to obtain a fourth reactant liquid. A volume flow ratio of the third reactant liquid to the fifth material was 3.5:1. The fourth reactant liquid was outputted from the third reactor to enter a fourth reactor to continue the esterification reaction at 75° C., so that the reaction raw materials are completely converted, so as to obtain an esterification product. The esterification product was transported to a fourth micromixer through a first back pressure valve. Reaction pressures in the third and fourth reactors were adjusted by the first back pressure valve. A sixth material (30.5 wt. % aqueous hydrogen chloride solution) was transported to the fifth micromixer by a sixth pump. The esterification product was fully mixed with the sixth material in the fifth micromixer, and then subjected to neutralization reaction for 2 min in a fifth reactor to obtain a fifth reactant liquid. A volume flow ratio of the sixth material to the esterification product was 1.5:2. The fifth reactant liquid was directly transported to a sixth reactor through a fourth connecting pipeline for hydrolysis reaction at 140° C. for 1 min to obtain a hydrolysis product. At the same time, the hydrolysis product was heated, and then transported to a bottom portion of a first reaction vessel through a second back pressure valve. Reaction pressures in the fifth and sixth reactors were adjusted by the second back pressure valve to improve the removal efficiency of low-boiling point solvent and compound in the first reaction vessel. The hydrolysis product was retained in the first reaction vessel at 100° C. for 30 min to allow the low-boiling point solvent and compound to evaporate quickly. The vaporized gas was transported to a condensation collector through a fifth connecting pipeline. The remaining reaction mixture flowed upward from the bottom portion of the first reaction vessel to enter an upper outlet of the first reaction vessel, and then transported to a bottom portion of a second reaction vessel (125° C., 45 min) through a sixth connecting pipeline to remove the generated methyl chloride and part of water. The remaining reaction mixture flowed upward from the bottom portion of the second reaction vessel to enter an upper outlet of the second reaction vessel, and then transported to a lower portion of a third reaction vessel (145° C., 45 min) to allow complete hydrolysis and dealcoholization reaction. The obtained reaction product was transported to a continuous crystallizer for cooling crystallization at 70° C. for 12 min, so as to obtain a glyphosate finished product with a purity greater than 98% and a yield of 84% based on glycine.

### Embodiment 3

A first material (0.84 kg/L of polyformaldehyde) was transported to a first micromixer by a first pump, and a second material (triethylamine) was transported to the first micromixer by a second pump. A volume flow ratio of the first material to the second material was 1.5:1. The first material and the second material were fully mixed in the first micromixer to obtain a first reactant liquid. The first reactant liquid was directly transported to a first reactor through a first connecting pipeline for depolymerization reaction of paraformaldehyde at 55° C. for 7 min to obtain a second reactant liquid. The second reactant liquid flowing out of the first reactor and a third material (0.45 kg/L of glycine) delivered by a third pump were fully mixed in a second micromixer, and then transported to a second reactor for addition reaction at 60° C. for 8 min to obtain a third reactant liquid. A volume flow ratio of the second reactant liquid to the third material was 1.5:1. The third reactant liquid was transported to a buffer tank through a second connecting pipeline, and then transported to a third micromixer by a fourth pump. A fifth material (dimethyl phosphite) was transported to the third micromixer by a fifth pump, such that the fifth material was fully mixed with the third reactant liquid, and then transported to a third reactor through a third connecting pipeline for esterification reaction at 62° C. for 8 min to obtain a fourth reactant liquid. A volume flow ratio of the third reactant liquid to the fifth material was 3.0:1. The fourth reactant liquid was outputted from the third reactor to enter a fourth reactor to continue the esterification reaction at 80° C., so that the reaction raw materials are completely converted, so as to obtain an esterification product. The esterification product was transported to a fourth micromixer through a first back pressure valve. Reaction pressures in the third and fourth reactors were adjusted by the first back pressure valve. A sixth material (31.5 wt. % aqueous hydrogen chloride solution) was transported to the fifth micromixer by a sixth pump. The esterification product was fully mixed with the sixth material in the fifth micromixer, and then subjected to neutralization reaction for 1.5 min in a fifth reactor to obtain a fifth reactant liquid. A volume flow ratio of the sixth material to the esterification product was 1.3:2. The fifth reactant liquid was directly transported to a sixth reactor through a fourth connecting pipeline for hydrolysis reaction at 120° C. for 0.8 min to obtain a hydrolysis product. At the same time, the hydrolysis product was heated, and transported to a bottom portion of a first reaction vessel through a second back pressure valve. Reaction pressures in the fifth and sixth reactors were adjusted by the second back pressure valve to improve the removal efficiency of low-boiling point solvent and compound in the first reaction vessel. The hydrolysis product was retained in the first reaction vessel at 120° C. for 25 min to allow the low-boiling point solvent and compound to evaporate quickly. The vaporized gas was transported to a condensation collector through a fifth connecting pipeline. The remaining reaction mixture flowed upward from the bottom portion of the first reaction vessel to enter an upper outlet of the first reaction vessel, and then transported to a bottom portion of a second reaction vessel (135° C., 40 min) through a sixth connecting pipeline to remove the generated methyl chloride and part of water. The remaining reaction mixture flowed upward from the bottom portion of the second reaction vessel to enter an upper outlet of the second reaction vessel, and then transported to a lower portion of a third reaction vessel (150° C., 42 min) to allow complete hydrolysis and dealcoholization reaction. The obtained reaction product was transported to a continuous crystallizer for cooling crystallization at 68° C. for 15 min, so as to obtain a glyphosate finished product with a purity greater than 97% and a yield of 83.5% based on glycine.

Any other changes and modifications made by those skilled in the art without departing from the spirit of the application shall fall within the scope of this application defined by the appended claims.

What is claimed is:

1. A device for fully-continuous synthesis of glyphosate, comprising:
a first feed pump;
a second feed pump;
a third feed pump;
a fourth feed pump;
a fifth feed pump;
a sixth feed pump;
a seventh feed pump;
a first micromixer;
a second micromixer;
a third micromixer;
a fourth micromixer;
a first microchannel reactor;
a second microchannel reactor;
a third microchannel reactor;
a fourth microchannel reactor;
a fifth microchannel reactor;
a sixth microchannel reactor;
a first stirring vessel;
a second stirring vessel;
a third stirring vessel;
a buffer tank;
a first back pressure valve;
a second back pressure valve; and
a continuous crystallizer;
wherein
the first feed pump is configured to transport a first material to the first micromixer, and the second feed pump is configured to transport a second material to the first micromixer, wherein the first material is a paraformaldehyde solution, and the second material is a solvent-free alkali or an alkali solution;
the first micromixer is configured to mix the first material with the second material to obtain a first mixture, and transport the first mixture to the first microchannel reactor through a first pipeline;
the first microchannel reactor is configured for depolymerization of paraformaldehyde to obtain a first reaction liquid, and transport the first reaction liquid to the second micromixer;
the third feed pump is configured to transport a third material to the second micromixer, wherein the third material is a glycine solution or dispersion;
the second micromixer is configured to mix the first reaction liquid with the third material to obtain a second mixture, and transport the second mixture to the second microchannel reactor;
the second microchannel reactor is configured for addition reaction of the second mixture to obtain a second reaction liquid;
the buffer tank is configured to receive the second reaction liquid from the second microchannel reactor through a second pipeline;
the fourth feed pump is configured to transport the second reaction liquid from the buffer tank to the third micromixer, and the fifth feed pump is configured to transport a fourth material to the third micromixer, wherein the fourth material is a solvent-free dimethyl phosphite or a dimethyl phosphite solution;
the third micromixer is configured to mix the second reaction liquid with the fourth material to obtain a third mixture, and transport the third mixture to the third microchannel reactor through a third pipeline;
the third microchannel reactor is connected to the fourth microchannel reactor, and the third microchannel reactor and the fourth microchannel reactor are configured for esterification of the third mixture to obtain a third reaction liquid; wherein a temperature of the fourth microchannel reactor is higher than that of the third microchannel reactor;
the first back pressure valve is configured to adjust a reaction pressure in the third microchannel reactor and a reaction pressure in the fourth microchannel reactor, and transport the third reaction liquid from the fourth microchannel reactor to the fourth micromixer;
the sixth feed pump is configured to transport a fifth material to the fourth micromixer, wherein the fifth material is a solvent-free acid or an acid solution;
the fourth micromixer is configured to mix the third reaction liquid with the fifth material to obtain a fourth mixture, and transport the fourth mixture to the fifth microchannel reactor;
the fifth microchannel reactor is configured for neutralization of the fourth mixture to obtain a fourth reaction liquid, and transport the fourth reaction liquid to the sixth microchannel reactor through a fourth pipeline;
the sixth microchannel reactor is configured for hydrolyzing and heating the fourth reaction liquid to obtain a first hydrolysis product;
the second back pressure valve is configured to adjust a reaction pressure in the fifth microchannel reactor and a reaction pressure in the sixth microchannel reactor, and transport the first hydrolysis product from the sixth microchannel reactor to a lower inlet of the first stirring vessel;
the first stirring vessel is configured such that the first hydrolysis product undergoes desolventization at a lower portion of the first stirring vessel to obtain a first desolvated product and a vaporized gas; the vaporized gas enters a condensation collector through a fifth pipeline; the first desolvated product is allowed to flow upward from the lower portion of the first stirring vessel, leave the first stirring vessel from an upper outlet, and enter a lower portion of the second stirring vessel through a sixth pipeline;
the second stirring vessel is configured for desolventization of the first desolvated product to obtain a second desolvated product; the second product is allowed to flow upward from the lower portion of the second stirring vessel to an upper outlet of the second stirring vessel, and enter a lower portion of the third stirring vessel through a seventh pipeline for hydrolysis and dealcoholization to obtain a second hydrolysis product; and
the continuous crystallizer is configured to perform cooling crystallization on the second hydrolysis product discharged from the third stirring vessel to obtain a glyphosate product.

2. The device of claim 1, wherein the first feed pump and the third feed pump are each independently a peristaltic pump for slurry feeding, and the second feed pump, the fourth feed pump, the fifth feed pump, the sixth feed pump and the seventh feed pump are each independently a plunger pump for liquid feeding.

3. The device of claim 1, wherein the first micromixer, the second micromixer, the third micromixer and the fourth micromixer are each independently a micromixer composed of four rhombus tubular mixing components connected in series; and each of the four rhombus tubular mixing components has a circular cross-section or a square cross-section, a fluid channel size of 100 μm-20 mm, a length of 1-100 cm and an applicable flux of 1-3000 mL/min.

4. The device of claim 1, wherein the second microchannel reactor is a rotary dynamic reactor having a cylindrical cavity; a wall of the cylindrical cavity is a heat-exchange fluid interlayer for a heat exchange fluid to pass through; a central shaft is provided in the cylindrical cavity; a plurality of stirring paddles are connected to the central shaft to enhance mass transfer and heat transfer; the central shaft is configured to be driven by a motor to rotate at 50-500 rpm; and the cylindrical cavity has a diameter of 3-60 cm, a length of 20-500 cm and an applicable flux of 10-50,000 mL/min.

5. The device of claim 1, wherein the first microchannel reactor, the third microchannel reactor, the fourth microchannel reactor, the fifth microchannel reactor and the sixth microchannel reactor are each independently a tubular microreactor with a plurality of square mixing components axially provided therein; and the tubular microreactor has a fluid channel size of 2-500 mm, a length of 1-10000 m and an applicable flux of 10-50,000 mL/min.

6. The device of claim 1, wherein a pipeline connecting the fourth microchannel reactor and the first back pressure valve, a pipeline connecting the first back pressure valve and the fourth micromixer, a pipeline connecting the six microchannel reactor and the second back pressure valve, and a pipeline connecting the second back pressure valve and the lower inlet of the first stirring vessel each have an inner diameter of 1.6-20 mm and a pressure adjustment range of 0.1-2.0 MPa.

7. The device of claim 1, wherein the first stirring vessel, the second stirring vessel and the third stirring vessel are each independently a stirring vessel having a stirring paddle, a distillate outlet, a heat exchange jacket, a heat exchange fluid inlet, a heat exchange fluid outlet, a material inlet and a material outlet; and the first stirring vessel, the second stirring vessel and the third stirring vessel are connected in series through the sixth pipeline and the seventh pipeline; and the first stirring vessel, the second stirring vessel and the third stirring vessel each have an inner diameter of 5-1000 cm and a height of 5-1000 cm.

8. The device of claim 1, wherein the continuous crystallizer is a tubular reactor having a mixing structure and a heat exchange jacket; the tubular reactor has an S-shaped inner tube and an S-shaped outer tube; a heat exchange interlayer is provided between the S-shaped inner tube and the S-shaped outer tube for a heat exchange fluid to pass through; a plurality of spherical baffles are arranged evenly spaced apart in the S-shaped tube; and the tubular reactor has an inner diameter of 2-20 cm, a length of 1-1000 m and an applicable flux of 10-5,000 mL/min.

9. The device of claim 1, wherein the first microchannel reactor is configured to operate at 30-60° C. for 1-9 min;
the second microchannel reactor is configured to operate at 45-80° C. for 6-12 min;
the third microchannel reactor is configured to operate at 50-80° C. for 1-8 min;
the fourth microchannel reactor is configured to operate at 60-90° C. for 5-15 min;
the fifth microchannel reactor is configured to operate at 0-30° C. for 0.5-3 min;
the sixth microchannel reactor is configured to operate at 90-190° C. for 0.5-3 min;
the first stirring vessel is configured to hold the first hydrolysis product at 80-150° C. for 5-40 min;
the second stirring vessel is configured to hold the first desolvated product at 80-150° C. for 5-40 min;
the third stirring vessel is configured to hold the second desolvated product at 90-160° C. for 5-60 min; and
the continuous crystallizer is configured to operate at 0-80° C. for 1-30 min.
